(19) United States
(12) Patent Application Publication
(10) Pub. No.: US 2013/0045006 A1
(43) Pub. Date: Feb. 21, 2013

(54) METHOD AND A NETWORK NODE FOR IMPROVING BANDWIDTH EFFICIENCY IN AN OPTICAL NETWORK

(71) Applicants: David Jimmy DAHAN, Ramat Gan (IL); Uri Mahlab, Or Yehuda (IL)

(72) Inventors: David Jimmy DAHAN, Ramat Gan (IL); Uri Mahlab, Or Yehuda (IL)

(73) Assignee: ECI Telecom Ltd., Petach Tikva (IL)

(21) Appl. No.: 13/564,470

(22) Filed: Aug. 1, 2012

(30) Foreign Application Priority Data
Aug. 1, 2011 (IL) 214391

(51) Int. Cl. H04B 10/08

(52) U.S. Cl. 398/34

(57) ABSTRACT

A method and system are provided for improving bandwidth efficiency in an optical network by dynamically utilizing unused bandwidth located around preliminarily allocated optical channels. The method comprising monitoring actual bandwidth of the preliminarily allocated optical channels incoming to a node of the optical network, reporting the monitoring results to the controller of that node and further to a network controller, receiving at that node recommendations generated by the network controller, adjusting bandwidth of one or more of the allocated optical channels thereby releasing spare bandwidth for inserting one or more additional optical channels thereat.

### CROSS-REFERENCE TO RELATED APPLICATIONS

This application claims priority of Israel Patent Application No. 214391, filed Aug. 1, 2011, the disclosure of which is incorporated by reference herein in its entirety.

### TECHNICAL FIELD

The present invention relates to technologies for dynamic management of bandwidth in optical networks to improve bandwidth efficiency, and in particular—for improving management of the optical bandwidth in network sections comprising channels of gridless or mini-grid flexible networks.

### BACKGROUND

Flexibility to support mesh topologies, dynamic capacity allocation, and automatic network control and light path setup are key elements in the design of next-generation optical transport networks. To realize these capabilities, Reconfigurable Optical Add/Drop Multiplexers (ROADM) with dynamic add/drop structures, embedded control planes, and light-path characterization are required. A light path is a pre-established optical circuit carrying an optical channel. New challenges are raised in order to optimally manage the network by dynamically increasing the network spectral efficiency and, particularly, for the optimal integration of legacy network services (based on 50 GHz or 100 GHz fixed channel spacing) into gridless or mini-grid flexible networks where the channel frequency and channel allocated bandwidth are flexible.

There are some attempts in the prior art, trying to increase capacity of optical networks by optimizing Spectral Efficiency (SE) of the optical channels. Only recently, technological limitations of the capacity has been reached with channels at 100 Gbit/s operating on both orthogonal polarization tributaries at 50 GHz grid and providing spectral efficiency of 2 bit/s/Hz. The spectral efficiency (SE) is defined as Bit Rate divided by the channel spacing. The SE can also be called bandwidth efficiency.

Pushing for bit rate capacity beyond 100 Gbit/s will require developing complex optical modulation schemes based on single or multi carrier approaches. These high bit rate channels (400 Gbit/s or 1 Tbit/s) will occupy optical bandwidth higher than 100 GHz and therefore will not be compliant with a fix grid network of 50 GHz or 100 GHz.

Two factors are responsible for the limitation of the spectral efficiency achievable at a given Optical Signal to Noise Ratio (OSNR). Firstly, the channel bit rate, and secondly the spectral inefficiency of the ROADM due to unused spectrum between adjacent channels. Furthermore, optimization of the spectral efficiency becomes more challenging when a plurality of bit rates, modulation formats and channels spacing are deployed in the network.

This can be partially addressed by increasing the spectral resolution and the bandwidth flexibility of the wavelength selective switching (WSS) technologies which allow minimizing the ratio of unused portions of spectrum.

A ROADM provides flexibility to switch optical channels that traditionally have center frequencies as defined by the International Telecommunication Union—Telecommunication Standardization Sector (ITU-T) grid. According to ITU-T G.694.1, the frequency of an optical channel is defined with respect to a reference frequency of 193.10 THz, or 1552.52 nm in wavelength.

The frequency difference between adjacent optical channels, referred to as channel spacing, can range from 12.5 to 100 GHz and wider. 100 and 50 GHz are common channel spacings used in optical networks today. Most tunable lasers used in transmitters are designed to have frequency locking mechanisms that align the frequency of the channel with the grid. As the data rate of an optical channel continues to increase, advanced modulation has successfully squeezed 40 Gb/s channels and 100 Gb/s channels into a 50 GHz channel spacing, that was originally designed for 10 Gb/s channels. To fit channels with high data rates into small channel bandwidths, especially for the 100 Gb/s signals, the modulation format has moved away from classical on-off keying. Multilevel amplitude and phase modulation have been introduced to reduce the overall optical bandwidth of a channel. The most prominent example is the PM-QPSK (Polarization Multiplexed-Quadrature Phase Shift Keying) format generally used for 100 Gb/s channels. Since with PM-QPSK the symbol rate of the 100 Gb/s signal is only one fourth the data rate, the modulated signal fits into a 50 GHz channel spacing network. By using 50 GHz channel spacing for 100 Gb/s channels, the optical spectral efficiency has increased 10 times to 2 b/s/Hz when compared to supporting 10 Gb/s signals.

Foreseeing higher channel data rates and greater spectral efficiency requirements in the near future, innovation in ROADM designs will be required as shown by the concepts of tunable channel bandwidth [1] and “elastic optical path” [2]. Since an increase in spectral efficiency of the modulation format requires an exponential increase in SNR [3] it is not likely that channels with data rates beyond 100 Gb/s will be designed with a 50 GHz channel spacing for long-haul network transmission distances. Flexibility to increase the symbol rate as well as spectral efficiency will allow optimizing the reach of long-haul optical channels with a data rate higher than 100 Gb/s such as 400 Gb/s and 1 Tb/s. In order to further increase the spectral efficiency, the required bandwidth of these channels with ultrahigh data rates should be minimized. For example, the bandwidth of a 400 Gb/s channel (using PM (Polarization Multiplexed) 16-QAM with 56-64 Gbaud) is likely to require only a 75 GHz channel spacing, while a 1 Tb/s channel (using PM 32-QAM with 112-128 Gbaud) would require only a 150 GHz channel spacing. This development imposes a fundamental change in ROADM design, since current ROADMs have fixed and equal channel spacing with the center frequencies of the channels anchored to the ITU-T grid. A transport system supporting mixed channels with data rates of 100 Gb/s, 400 Gb/s, and 1 Tb/s will require ROADMs that support flexible add/drop bandwidths and tunable lasers that lock to frequencies with subchannel spacing (e.g., 12.5 GHz), as different channels may have different bandwidths.

Current WSS technologies based on one dimension MEMS (Micro Electro-Mechanic Systems) or Liquid Crystal (LC) enable to develop ROADM with fixed switching bandwidth which is determined by the fabrication process.

The concept of ROADM with flexible add/drop bandwidth has already been introduced in ROADM designs [4-5], and Liquid Crystal on Insulator (LCoS) or Digital Light processor (DLP) mirror arrays technologies can meet the flexible bandwidth requirement enabling an efficient bandwidth management of the optical network.

US 2004142696 describes a spectral reuse transceiver-based communication system which conducts communications between a master site and a plurality of remote sites using a selected portion of a communication bandwidth containing a plurality of sub-bandwidth channels. Each remote site transceiver monitors the communication bandwidth for activity on the sub-bandwidth channels, and informs a master site transceiver which sub-bandwidth communication channels are absent communication activity and therefore constitute clear channels. The master site transceiver compiles an aggregate list of clear channels from all the remote sites and then broadcasts the aggregate list to the remote sites. The master site and a remote site then conduct communications there-between by frequency-hopping and/or orthogonal frequency multiplexing among the clear channels using an a priori known PN sequence.

U.S. Pat. No. 5,949,832 describes a digital data receiver which includes a tunable analog matched filter circuit having a variable bandwidth responsive to the bit error rate (BER) of the decoded data. The bandwidth of the analog filtering circuit is controlled by a tuning control signal that includes a coarse tuning signal combined with a fine tuning signal. The coarse tuning signal is generated by a frequency-to-current converter and the fine tuning signal is generated by a current-scaling digital-to-analog converter (DAC). The DAC input signal is produced by a DAC control circuit that includes a BER comparator and a DAC control state machine. The BER comparator determines whether the BER has improved or degraded in response to a previous tuning command. To optimize the BER in the decoded data signal, the state machine increments or decrements the value of the fine tuning signal, which in turn alters the filter bandwidth.

US 2011033188 describes a data transport card comprising an interface to receive high speed data streams from at least one client, and a pluggable conversion module which converts the data streams into optical data signals and couples these optical data signals into at least one wavelength division multiplexing channel for transport of said optical data signals via an optical fibre. The wavelength division multiplexing (WDM) channel may have a predetermined bandwidth and may comprise a number of WDM subchannels corresponding to a number (N) of received data streams DS. The pluggable conversion module (5) may comprise at least one tunable optical signal reshaper (TOSR) (5B) being adaptable to the bandwidth and to the spacing of said WDM subchannels to optimize WDM subchannel power levels (P) and to minimize crosstalk. The tunable optical signal reshaper (TOSR) (5B) is provided for spectrum-shaping of said WDM subchannels, wherein WDM subchannel bandwidths and the spacing of the subchannel center frequencies are adjusted to minimize the bit error rate (BER) of said optical data signals. The WDM-subchannel spacing can be adapted.

### SUMMARY OF THE DISCLOSURE

To the best of the Applicant's knowledge, prior art solutions do not resolve the problem of effective bandwidth utilization in optical networks where various grids may co-exist, or where additional optical channels need to be inserted between existing channels.

It is an object of the present invention to propose a novel method and a novel apparatus in order to dynamically increase capacity of an optical network by optimizing its channel Spectral Efficiency (SE). Only recently, technological limitations of the capacity has been reached with channels at 100 Gbit/s operating on both polarization planes at 50 GHz grid and providing spectral efficiency of 2 bit/s/Hz. In other words, a fixed grid of 50 GHz does not allow deploying a channel with bit rate higher than 100 Gbps, since the bandwidth required for such a high rate signal is greater than the channel spacing so that neighbor channels start overlapping one another.

The present invention provides novel methods and technologies in order to optimize the optical network capacity by dynamically reducing/narrowing unused preliminarily allocated optical bandwidth, for example by utilizing flexible optical switching bandwidth technologies, such as a novel ROADM node, provided with its associated node control unit interconnected with a network controller or NMS.

The basic idea (and the object) is providing high spectral efficiency of an optical network by utilizing spare bandwidth around optical signals initially existing/being transmitted via the network (and based on channel spacing that supposedly allows to insert additional information therein).

There is proposed a method of optimizing optical network bandwidth capacity by dynamically reducing unused spacing of preliminarily/previously allocated optical bandwidth, by monitoring actual bandwidth of optical channels incoming one or more nodes of the network, reporting the monitoring results via node controllers of said nodes to a network controller, receiving recommendations of the network controller at said one or more nodes and further adjusting the allocated bandwidth thus freeing previously non-accessible bandwidth spacing for utilizing thereof, according to the recommendations received at said nodes.

In other words, it can be formulated as a method for improving bandwidth/spectral efficiency in an optical network by dynamically utilizing unused spacing around preliminarily allocated optical channels, by monitoring actual bandwidth of the preliminarily allocated optical channels incoming a node of the optical network, reporting the monitoring results to a node controller of said node and further to a network controller, receiving recommendations of the network controller at said node, adjusting bandwidth of one or more of the allocated optical channels thereby freeing spare bandwidth spacing for inserting one or more additional optical channels.

The idea may be implemented, for example, by utilizing concepts and networks with gridless spacing or small (or even mini-grid) flexible bandwidth, by inserting additional channels into such a grid/spacing. Especially advantageous are cases where the proposed method is utilized for inserting additional optical channels between channels of gridless or mini-grid flexible networks, for example where the grid granularity is less than 50 GHz. In such a case existing channels may be shifted, say at a specific node, from one another so as to produce a broader spacing there-between, and additional channel(s) may be inserted into thus obtained broader spacing. Since various multiples of the mini-grid spacing may be thus formed, additional optical channels of other channel grids may be combined with the basic flexible mini-grid.

The object can be achieved by a three-step method, where
a first step is monitoring an existing grid of channels in the network and finding suitable remaining bandwidth in the existing grid of channels for further use;
a second step is actually freeing suitable bandwidth around existing channel(s), for inserting additional information/sub-channels.
   For example, it can be performed by regulating optical filter(s) of one or more specific existing channels based on measuring BER of the signal transmitted in said channel(s). The regulation preferably comprises slightly shifting the bandpass of the filter of interest and shaping it, to free space for new channels; the bandwidth may be shifted with simultaneously controlling the channel quality by means of measuring BER; Alternatively, the bandwidth of a specific channel at a particular node may be shifted/adjusted according to information about the minimum required optical bandwidth of the channel, for example provided by a so-called traffic mapper which may be located in a network controller NC/NMS or the like (this information may belong to prior knowledge stored in the network controller NC).
at a third step, the freed/flexible space (portions of spacing) can be further utilized, i.e. additional channels may be inserted into the freed portions of the spacing. The third step preferably comprises preliminarily monitoring additional channels to be inserted and, possibly, shaping/narrowing also BW of these additional channels.

The first step may comprise spectral monitoring of a specific signal in an optical channel of a basic, for example a broader grid (spacing),

The second step may comprise using a tunable, flexible filter to narrow the signal's bandwidth (BW) and to obtain free space in the grid.

The third step may comprise inserting into the freed space an additional signal being gridless, or having a narrower grid (spacing).

Actually, the method may comprise interleaving channels of different grids with preliminarily cleaning the unoccupied/unused bandwidth from noise, and/or with narrowing the existing (or previously allocated) optical bandwidth.

Optionally, the method may comprise interleaving channels of different grids with preliminarily shifting frequency optical bands of one or more channels of a basic grid (or just of preliminarily allocated optical channels). The shifting of frequency band(s) is understood as shifting central frequency of the channel(s). Such an operation becomes possible if a wavelength shifting element is present in a network node where such wavelength/bandwidth shift is required. The bandwidth/wavelength shift can be performed in an optical domain using optical nonlinear effects such as Four Wave Mixing (FWM) or using a nonlinear Semiconductor Amplifier (SOA). Alternatively, it can be done using an optoelectronic repeater (constituted by a receiver and a tunable transmitter). Since such a wavelength/bandwidth shifting element has a non-negligible cost, the wavelength/bandwidth shifting procedure should preferably be done when other options (such as bandwidth shaping/reduction or channel switching to another lightpath) either do not exist, or do not solve the problem.

Preferably, a flexible small-granulated grid (“mini-grid”) may be selected as the basic existing grid wherein a broader grid specific channel(s) may be inserted in the freed space after shifting channels of the basic grid.

The present invention particularly addresses solutions for optimal integration of legacy network services (for example, based on 50 GHz or 100 GHz fixed channel spacing) into grid-free or smaller grid flexible networks where the channel frequency and channel allocated bandwidth are flexible.

The Inventors propose that in the new method, at least for flexible grid networks where the channel bandwidth may vary from 10 GHz to 350 GHz, a channel representation be modified (since the channel wavelength is not enough to define the signal). The monitoring should provide suitable tools for detecting/measuring bandwidth of an optical channel, and the information about the optical channel should comprise defining of the channel as frequency optical bands [fᵢ, fⱼ] where fᵢ is the minimal frequency and fⱼ is the maximal frequency.

From a network point of view, the method further comprises the following steps:

in case new service(s), say in the form of one or more optical channels, is/are to be added at a specific node, a request is sent by a management entity of the network, such as a network management engine (NTME) to Node Traffic Controllers (NTC) of one or more network nodes. In return, each of said nodes, via its NTC, sends to the NTME the list of unused available spectral band segments (in a specific example, at the node outputs).

The proposed concept can be implemented in an optical switching network node—such as an OADM or a cross-connecting network node comprising a node Traffic controller NTC (for example, the internal controller of the node) which in turn communicates with a network controller NC (NMS or the like such as NTME—network traffic management engine); the node further comprising:
one or more blocks for monitoring optical channels incoming the node from at least two sources (such as optical networks, local clients) having different grids of optical channels, and for informing the network controller NC about band occupancy—i.e., about wavelength and bandwidth of the incoming optical channels; (The bandwidth may be scanned per pixel by Spectrum analyzers)
one or more suitable bandwidth adjustment blocks, wherein each of such adjustment blocks:
   serving a group of incoming channels, for example optical channels arriving from a specific source/network (and characterized by a specific grid),
   being adapted to receive commands from the network controller NC (say, via the NTC) and, based on the received commands, to shape/narrow bandwidth of one or more incoming optical channels of the group so as to prepare space for inserting there-between optical channels arriving from another source/network (and characterized by another grid);

It should be kept in mind that the Node Traffic Controller should be adapted to collect band occupancy information from all of the monitoring blocks and to calculate (alone or in cooperation with NC) a possible arrangement of incoming channels in an optimized manner from the point of bandwidth utilization. In order to provide bandwidth efficient arrangement, at least one grid of those characteristic for different incoming optical channels should be flexible in advance.

The NTC of the node should be adapted to receive from the NC recommendations, commands and/or information, for example about minimum required optical bandwidth of various optical channels which may be stored in the NC in the form of a topological network map.

The monitoring block may comprise at least one optical monitoring element for providing accurate information on the optical power of a specific optical channel, in a fine spectral resolution, for example in the order of the frequency pixel resolution of the grid or about 1 GHz in the case of gridless network.

The mentioned optical monitor element can be an Optical Spectrum Analyzer (OSA) monitor which provides the information about the services bandwidth occupancy and unused optical bandwidths from the incoming links to the node as well as from the different, added local channels by measuring the optical power in a spectral resolution Δf.

It should be noted that the proposed invention (the method, the cross-connecting node) is compatible with legacy networks operating with channel spacing of 100 GHz and 50 GHz and with next generation gridless or mini-grid flexible networks (like 25 GHz or 12.5 GHz) with various modulation formats and required optical bandwidths. For example, a network with a flexible mini-grid of 25 GHz may support optical channels with bandwidth of 25, 50, 75, 100 GHz., etc.

The applicable modulation formats are, for example, OOK (On-Off Keying), [D]PSK ([Differential] phase shift keying), [D]QPSK ([Differential] Quaternary Phase Shift Keying), [D] M-PSK ([Differential] M-ary Phase Shift Keying), Self Homodyne (SH) M-PSK, OFDM (Orthogonal Frequency Division multiplexing), M-QAM (M-ary Quadrature Amplitude Modulation), DuoBinary, SSB (Single Side Band) modulations. Both NRZ and RZ optical line coding of the above modulations formats are applicable, as well as the Dual Polarization version of these modulation formats.

According to a further aspect of the invention, there is also proposed a new optical network comprising one or more of the above-described nodes and a Network Management Engine for optimizing bandwidth use in the network, being in communication with the described nodes.

There is also proposed a software product for supporting and ensuring operations of the proposed method. The software product comprises computer implementable instructions and/or data, for carrying out the above-described method, being stored on an appropriate non-transitory computer readable storage medium so that the software is capable of enabling operations of said method, when used in a computer system.

The software product blocks/modules may be distributed between and reside partially in the NTC of one or more network nodes (provided with the monitoring means communicating with the NTC) and partially in the networks controller such as NTME, which actually form the computer system of the software product.

The invention will be explained in more details as the description proceeds.

### BRIEF DESCRIPTION OF THE DRAWINGS

The invention will be further described and illustrated with reference to the following non-limiting drawings, in which:

FIG. 1A (prior art) presents illustration of a conventional DWDM channel allocation;

FIG. 1B presents an example of a desired bandwidth-flexible DWDM channel allocation suitable for supporting future 1-Tb/s and 400-Gb/s superchannels;

FIG. 2 schematically illustrates an exemplary combined optical network comprising sections with various grids: a metro network with 50 GHz fixed channel spacing, a metro network with 100 GHz fixed channel spacing, a core network which may, for example, have flexible spacing wherein the network sections are interconnected via a network node N1. A portion of the bandwidth allocation of service traffic flows arriving to node N1 and leaving node N1 is also illustrated;

FIG. 3A is a schematic block-diagram of one embodiment of the proposed scalable colorless, directionless and contentionless ROADM node, intended for bandwidth effective interconnection of optical networks with various types of grids. It schematically illustrates the network node N1 from FIG. 2, being for example a ROADM node, which receives incoming optical channels from different network sections and from local sources. A specific task to be resolved is increasing bandwidth efficiency at the output of the node N1. Some ways of implementing it are presented in the following figures;

FIG. 3B is an exemplary schematic block diagram of the local add and local drop block shown in FIG. 3a. It schematically illustrates the architecture of a local drop and a local add network elements (in the case of up to 4 channels), which enables colorless, directionless and contentionless features of the node.

FIG. 4A schematically illustrates an exemplary implementation of a combined circuit for monitoring the band occupancy of the channels arriving from a given link and providing the band occupancy information to the Node traffic Controller (NTC).

FIG. 4B shows the same concept as FIG. 4A but with the difference that optical spectrum is split in the monitor into different observation bands to reduce the monitoring scanning time;

FIG. 5 schematically illustrates how a flexible grid WSS (Wavelength Selective Switch), which may form part of the ROADM node N1, combines information transmitted over various optical channels arriving to the N1 from a number of sources/networks; and

FIG. 6 schematically shows how bandwidth monitoring in specific channels may be implemented by means of power monitoring, per pixel of frequency.

### DETAILED DESCRIPTION OF PREFERRED EMBODIMENTS

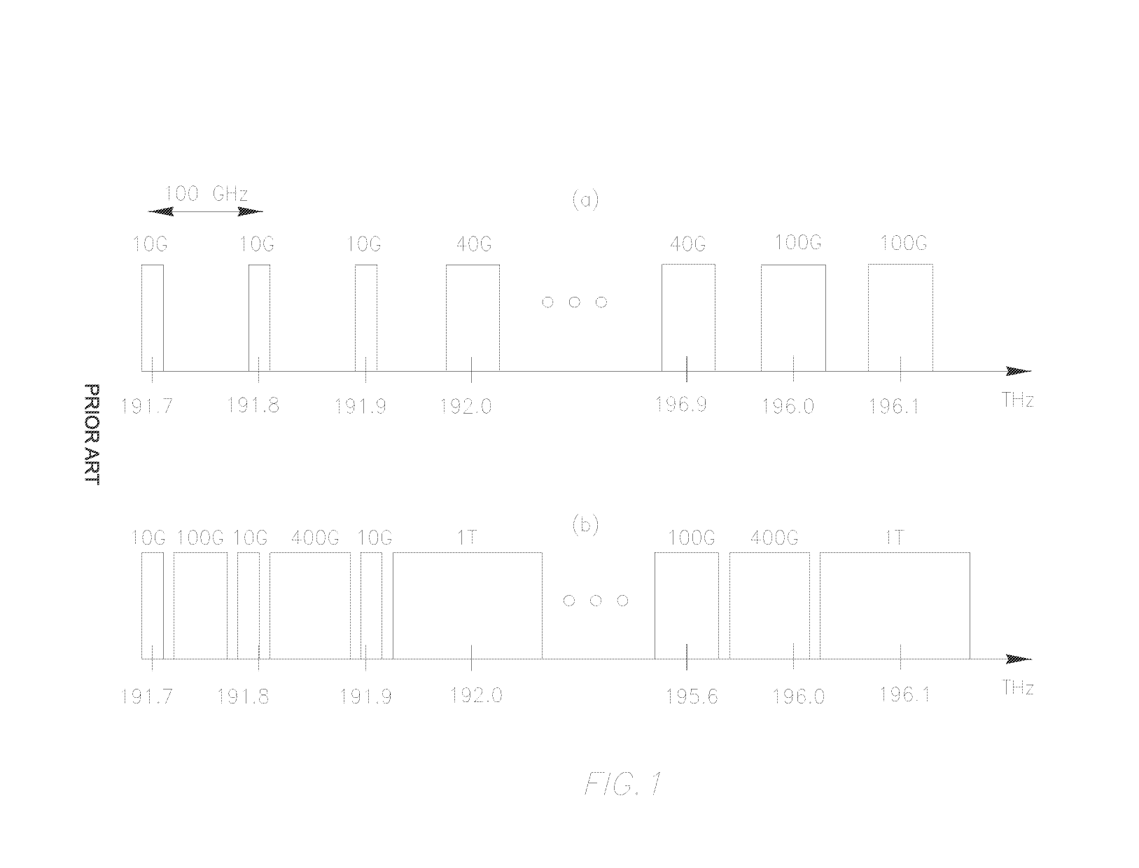

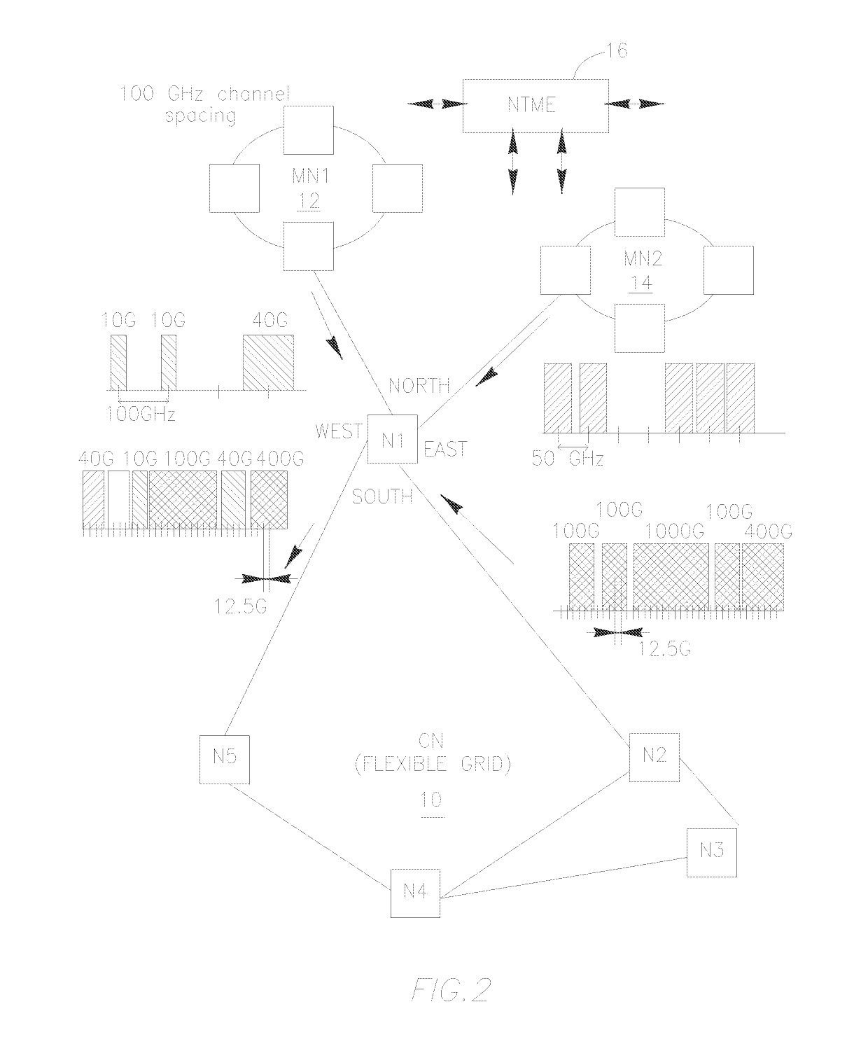

FIG. 1A illustrates a conventional 100 GHz channel spacing DWDM channel allocation with 10 Gb/s, 40 Gb/s and 100 Gb/s channels, while FIG. 1b—a bandwidth-flexible DWDM channel allocation which would be suitable for supporting future 1-Tb/s and 400-Gb/s superchannels along with 100 Gb/s channels.

FIGS. 1A and 1B show an example of comparison of the fixed ITU-T grid and a flexible grid for the C-band. When implementing a flexible grid, issues such as nonlinearity from mixed signal formats, and bit rates and optical power control when the number of channels varies dynamically must be considered. Also, operational and management issues such as channel numbering and bandwidth assignment need to be addressed. ROADMs with flexible bandwidth design are required to support dynamic add/drop of channels beyond 100 Gb/s.

The channel spacing in modern optical networks is typically 100 GHz, as shown in FIG. 1A; the figure allows seeing essential waste of unused optical bandwidth, especially when using 10 Gb/s signals. For future systems with 1-Tb/s and 400-Gb/s superchannels, the optical bandwidth needed for each channel is likely to be more than 50 GHz. This calls for a new DWDM channel allocation scheme where the channel bandwidth is flexible (adjustable) in order to support these high data-rate superchannels, as illustrated in FIG. 1B. This new type of DWDM can be called flexible DWDM or gridless DWDM which, though was mentioned as a desired type, has not yet been implemented in the way the Inventors propose. To achieve the maximum system spectral efficiency, the center of these superchannels may not coincide with the ITU 50-GHz or 100-GHz grid because of their nonstandard optical bandwidth requirements. On the other hand, it may cause too much architectural changes to completely abandon the well-established ITU grid. So, a plausible compromise would be to use a finer ITU grid, e.g., the 25-GHz grid or 12.5-GHz grid, but allow the channel bandwidth to be flexible, e.g., ranging from 10 GHz to 350 GHz, to efficiently support 10 Gb/s, 40 Gb/s, 100-Gb/s, 400-Gb/s, and 1-Tb/s channels. It is worth noting that an advantage of using OFDM-based superchannels is that only one laser (the seed) needs to be frequency controlled to a given channel location, while all the carriers in the superchannels are generated from the seed and are frequency locked to it.

Flexible grid networks present flexible optical bandwidth capabilities, meaning it is possible to choose the channel wavelength and channel frequency in a flexible way, with a frequency resolution of the channel bandwidth increment or reduction noted Δf. If the minimum frequency bandwidth FBₘᵢₙ>Δf the network is defined as a mini-grid flexible network while is FBₘᵢₙ=Δf, the network is defined as gridless flexible network.

These changes in the channel allocation and occupancy in the modern networks, in the Inventors' opinion, should drive new paradigms/approaches in the network management since the channel wavelength information is not enough in order to characterize the service bandwidth allocation since, for instance, the channel bandwidth may vary from 10 GHz to 350 GHz. In this description, the Inventors propose to perform monitoring and informing one or more managing entities of a node and/or a network about the real, changing bandwidth at a specific point of the network.

Let in a legacy fixed grid network the different channels are identified by their optical wavelength or frequency. For example, in a 50 GHz channel spacing network with the first channel located at frequency F₀, the channels are defined by their optical frequency, F, defined as Fᵢ=F₀+(i−1)×50 GHz

Such a channel representation is used by a specific network control and management plane for network planning and provisioning (using Routing Wavelength Assignment (RWA) algorithms), rerouting in case of failures and network maintenance (Power monitoring, OSNR monitoring, ROADMs routing procedures)

However, in flexible grid and gridless networks, since the channel bandwidth may vary from 10 GHz to 350 GHz, the Inventors propose to change the channel representation, since the channel wavelength is not enough to define the signal. More specifically, we propose defining the channels as frequency optical bands [fᵢ, fⱼ] where fᵢ is the minimal frequency and fⱼ is the maximal frequency. The total frequency WDM optical band, noted OB_{WDM} is defined by a set of M pixel frequencies with resolution Δf such as OB_{WDM}={fᵢ}_{i=0,M} with fᵢ=F₀+(i−1)×Δf. Using such a representation, for a channel defined by its spectral occupancy segment [fᵢ, fⱼ], its optical bandwidth is given by obw=fⱼ−fᵢ.

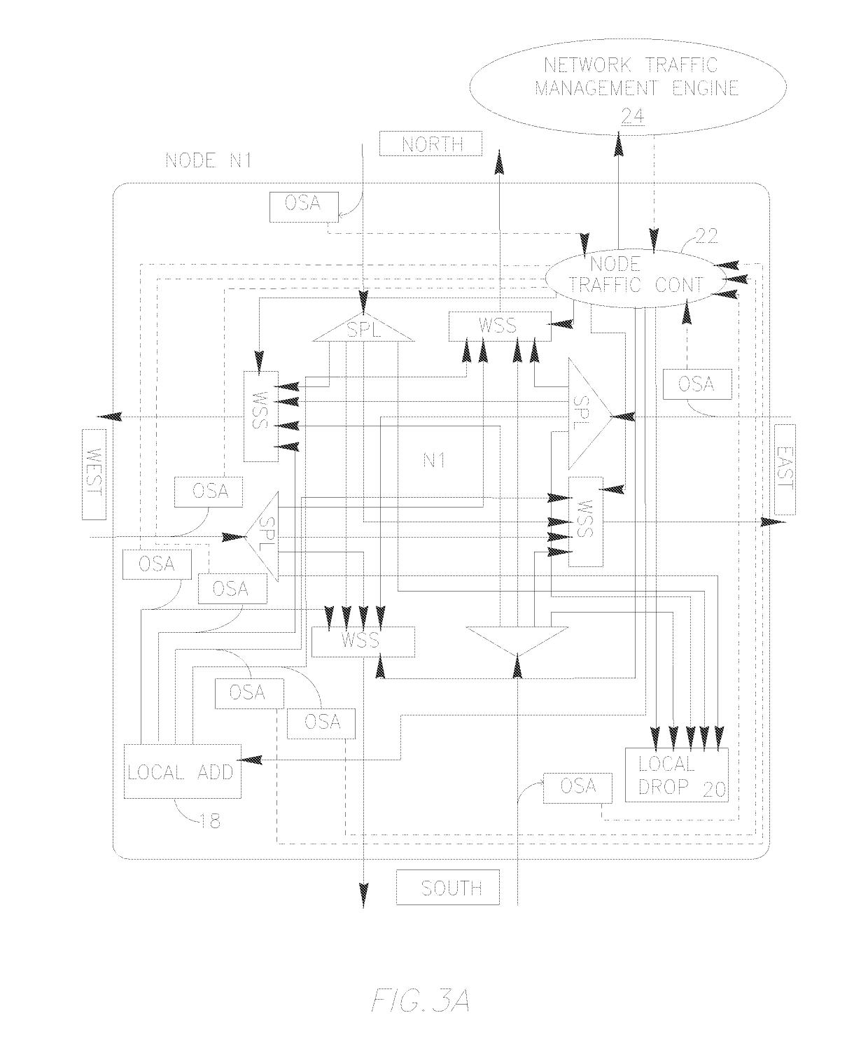

FIG. 2 shows an example of a gridless or flexible mini-grid optical core meshed network marked CN (10). Such a network presents multi degree nodes connected to different nodes of the core network CN as well as to nodes of metro networks (MN1/12, MN2/14) or access networks (not shown). Each network node Ni, such as N1-N5, is connected to one or more fiber links, for example N1 is connected to links carrying traffic from legacy networks at 50 GHz and 100 GHz fixed channel spacing, and to links carrying traffic from gridless or mini-grid flexible core network.

The network nodes can also present one or more features such as colorless, directionless and contentionless (or a combination of these features).

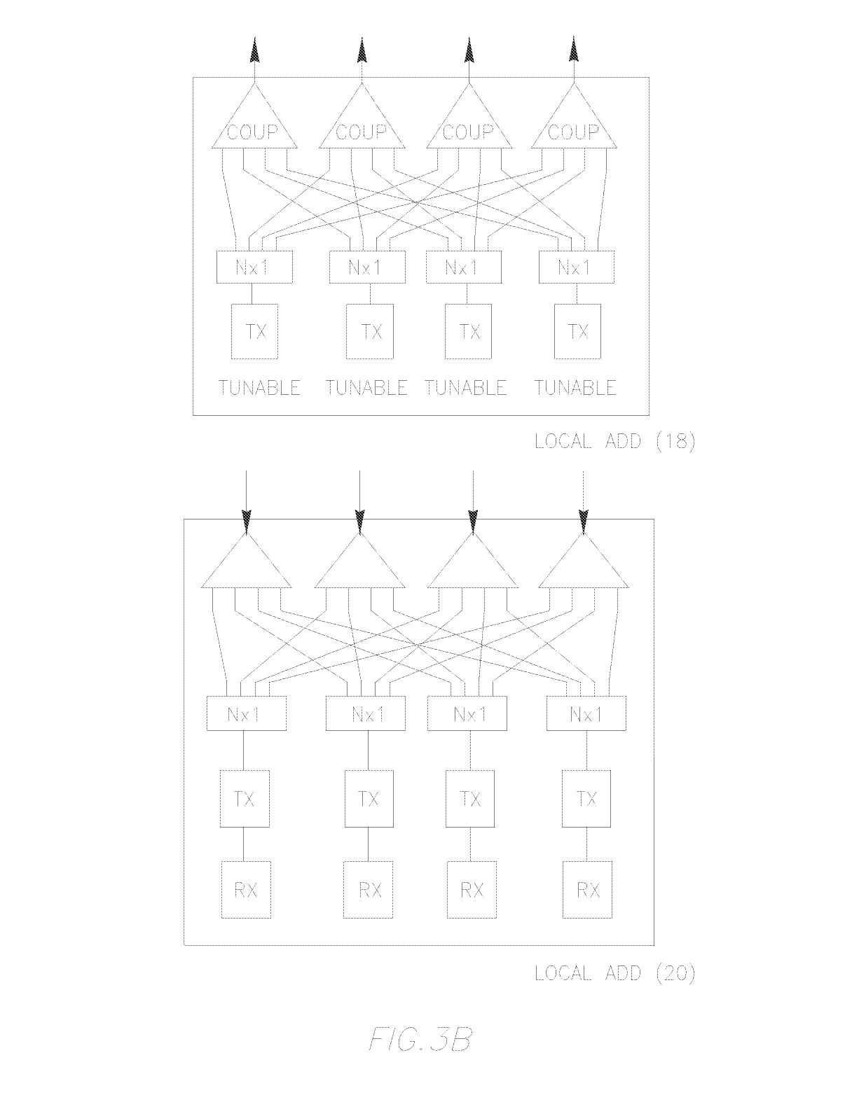

Optionally, local add and drop services can be performed at the core nodes (say, in a gridless manner, as shown in FIG. 3).

The network shown in FIG. 2 may have the desired flexible optical bandwidth capabilities. In a flexible grid network such as CN 10, preferably all the optical network elements present filtering capabilities (for example, by being wavelength selective switches WSS, multiplexers and demultiplexers) and exhibit flexible bandwidth and wavelength tunability. It should be taken into account, that more than one nodes in the illustrated network may be (and preferably, are) provided with the novel capabilities which are explained below on an example of a ROADM node N1. A network management engine (NTME 16) is in communication with a plurality of network nodes such as N1-N5 each provided with its node traffic controller (not shown in this drawing), for exchanging information and commands and for optimizing bandwidth utilization in the network.

FIG. 3A is a schematic example of a WSS based ROADM provided with the inventive functionality of monitoring all incoming optical channels, adjusting their bandwidth and combining information to be transmitted via ROADM with improved bandwidth efficiency. In a colorless network node, any wavelength can be assigned to any add/drop port of the ROADM. (In a conventional, colored network node, in order to reconfigure a service's wavelength color, the receiver must be moved to the port with the corresponding drop color.) To eliminate this constraint, fixed multiplexers and demultiplexers are removed. Wavelength selective switches (WSS) or tunable filters can be used to provide the colorless drop functionality (see FIG. 3B). In the local add, tunable transmitter combined with the WSS add unit of the RAODMs provides the colorless add functionality.

A directionless network node provides the freedom to direct a channel to any degree of the node and is implemented by connecting an add/drop structure to every degree on the ROADM via the splitters of the four degrees. The splitter acts as a broadcasting unit. There may be more than four degrees in an N-degree node, and there splitters with N outputs should be used.

A contentionless ROADM design removes wavelength restrictions from the add/drop portion of the ROADM node so that a transmitter can be assigned to any wavelength as long as the number of channels with the same wavelength is not more than the number of degrees in the node. This architecture guarantees that only one add/drop structure is needed in a node. The network planning is simplified since any add/drop port can support all colors and can be connected to any degree of the node.

Therefore, the modern ROADM is preferably a colorless, directionless, and contentionless ROADM.

The proposed method of optimized BW utilization is advantageous for such an ROADM node.

It should be noted that with such a colorless, directionless, and contentionless ROADM node, constraints on wavelength assignment are only removed from the add/drop structure. Wavelength assignment constraints still exist at the network level and require the use of a Routing Wavelength Allocation (RWA) algorithm platform, since two services with the same wavelength are not allowed on the same fiber connecting any two nodes [9]. Contentionless design, however, is able to reduce wavelength congestion problems/conflicts by optimizing the wavelength assignments dynamically or even automatically. Wavelengths can be reassigned by the network operator under software control, to ease wavelength conflicts in the network.

More specifically, FIG. 3A schematically shows an inset/zoom of the network node N1 which constitutes a four degrees/sides (marked North, South, West, East) node comprising colorless, directionless and contentionless features. Each node degree is connected to a multi degree ROADM. (The ROADM is a combination of a splitter as a drop unit function, and of a WSS as an add unit, the ROADMs form the node). In the present example, each of the ROADMs of a specific side comprises/uses its flexible bandwidth WSS element as an ADD module and its 1×4 splitter as a DROP module.

The traffic flows of all degrees of the node, as well as of the local added services are connected to different input ports of each WSSs. Each WSS has the ability to select a channel from each input port in order to send it to its express output port, according to a command of the ROADM controller (node traffic controller NTC 22).

In addition, “local drop” can also be performed at the node; the local drop block receives traffic of all the incoming node degrees (North, South, West, East), via the broadcasting function provided by the optical splitters. (The meaning is that the splitter broadcasts (copies) the incoming signals to all its output ports.)

The WSS element of the ROADM presents the flexible bandwidth capabilities, the meaning is that the WSS is able to allocate, for a given channel, a specific wavelength and an optimized channel bandwidth. The bandwidth of channels passing via each WSS of FIG. 3a can be optimized based on commands received from the node traffic controller NTC 22 which, in turn, receives monitoring information from monitoring blocks (in this drawing, multiple OSAs), and recommendations from a Network Controller (NTME 24) which holds a network map and data about required minimal bandwidth of various existing channels/services and additional channels to be added. The data about required minimal bandwidth of a channel depends on many factors, for example on the modulation format of the optical signal passing via the channel, bit rate, etc.

In addition, if sufficient amount of free bandwidth cannot be found, existing channels may be wavelength shifted under supervision of NTME and NTC. Such an operation will require one or more controllable wavelength shifting elements WSE (not shown). The WSE can be associated with WSS, at each degree of the node N1, and be controlled by NTC. WSE may utilize optical nonlinear effects such as Four Wave Mixing (FWM), may comprise a nonlinear Semiconductor Amplifier (SOA). Alternatively, it can be implemented using an optoelectronic repeater (constituted by a receiver and a tunable transmitter). Preferably, NTC and NTME should initiate wavelength/bandwidth shifting when no other options (such as bandwidth shaping, bandwidth reduction or channel switching to another lightpath) can be found to resolve a current problem.

In flexible gridless and flexible mini-grid optical networks, conventional optical channel power monitors do not provide efficient information in order to manage the network in the way the Inventors propose, since they provide the total channel optical power over a fixed optical bandwidth. The Inventors have suggested replacing them by optical monitoring elements that can provide accurate information on the optical power in a finer spectral resolution such as Δf. Such an optical monitoring element can be an Optical Spectrum Analyzer (OSA) monitor which, in this drawing and in the present concept, provides the information about the services bandwidth occupancy and unused optical bandwidths from the incoming links (as well as from the different added local channels) by measuring the optical power in a spectral resolution Δf. The determination of the service bandwidth occupancy is a very critical stage in the network management because of the plurality of the service bandwidths and the inherent channel wavelength drifts. The bandwidth occupancy information from all the OSA monitor modules (see 4a, 4b) is provided to the Node Traffic Controller (NTC) which receives the traffic mapping information from the Network Traffic Management Engine (NTME). In the traffic mapper, the route of each service is described, as well as additional information such as the service type, bit rate, modulation format and minimum required optical bandwidth of the service. The NTME manages the network using online Quality of service routing algorithms such as Routing and Spectrum Assignment (RSA) algorithms [10]. RSA algorithms enable to optimally allocate the channel optical bandwidth into the available optical band (usually the C or L-band) with the constraint of no bandwidth overlapping between different services within the same lightpath. The NTC 22, for example, may command the different WSS elements of the node N1, which select the outgoing services from the node and optimize their bandwidth according to the required optical bandwidth of the outgoing services, based on information provided to NTC by the NTME 24.

However, the NTME uses the information provided by the NTC about the presently unused optical bandwidths, to insert relevant services according to their required optical bandwidth and the existing traffic matrix (i.e., uses accumulative information).

The “clever” OSA monitoring blocks proposed by the Inventors are respectively associated with incoming and outgoing optical channels and are schematically shown in the drawing as multiple “OSA” boxes sending to the Node Traffic Controlled 22 dashed line reports about existing bandwidth conditions. Outgoing common signals from the E. W. N. S. degrees may also be monitored, but this is rather redundant since there is already information about monitoring the input traffic and the local added signals. This information in combination with the information provided by the node traffic controller and the NTME actually forms information on the outgoing traffic from the node.

FIG. 3B is an exemplary schematic block diagram of the local add and local drop blocks (18 and 20) shown in FIG. 3a. It schematically illustrates the architecture of such drop and add units, for the case of up to 4 optical channels (N=4). The local add block 18 comprises 4 tunable transmitters TX (say, tunable lasers), each one connected to a 1×N optical switch. Each output of the optical switches is connected to one of the inputs of four optical couplers. Such architecture enables colorless, directionless and contentionless features. Each optical transmitter TX, under control of the NTC 22, is adapted to shift the bandwidth of the channel to be added (if necessary), so as to judiciously accommodate the added channel in a required grid of channels. Each of the TX-s can use either a fixed bit rate/modulation format or can have a flexible bit rate together with an adaptive modulation format.

The local drop block 20 comprises 4 1×4 optical splitters which outputs are respectively connected to four “4×1” optical switches (marked N×1). The output of each of the optical switches is connected to an optical tunable filter TF and then to an optical receiver RX. Such architecture enables achieving features of colorless, directionless and contentionless. In addition, the tunable filters TF can also present flexible bandwidth capabilities (for example, may adjust the spectral position of the specific channel under supervision of the NTC 22)—and the optical receivers RX can use either a fixed bitrate/modulation format or can have a flexible bit rate together with an adaptive modulation format.

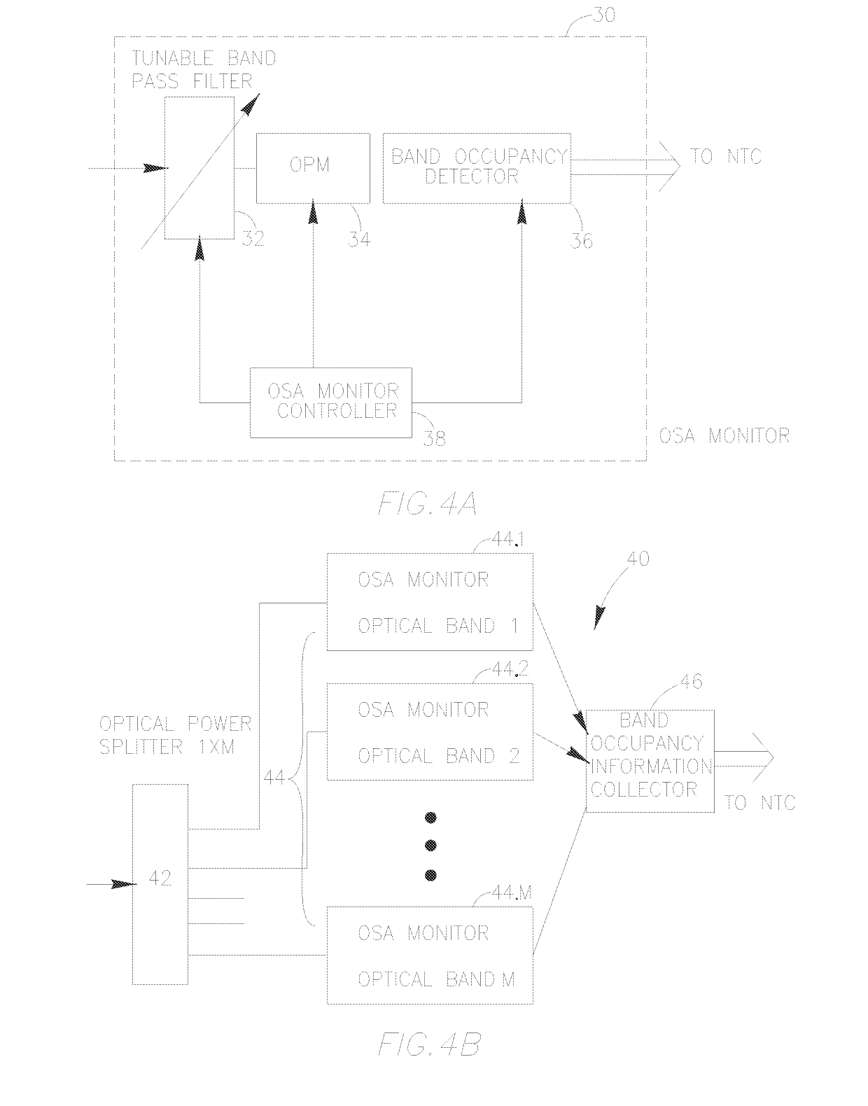

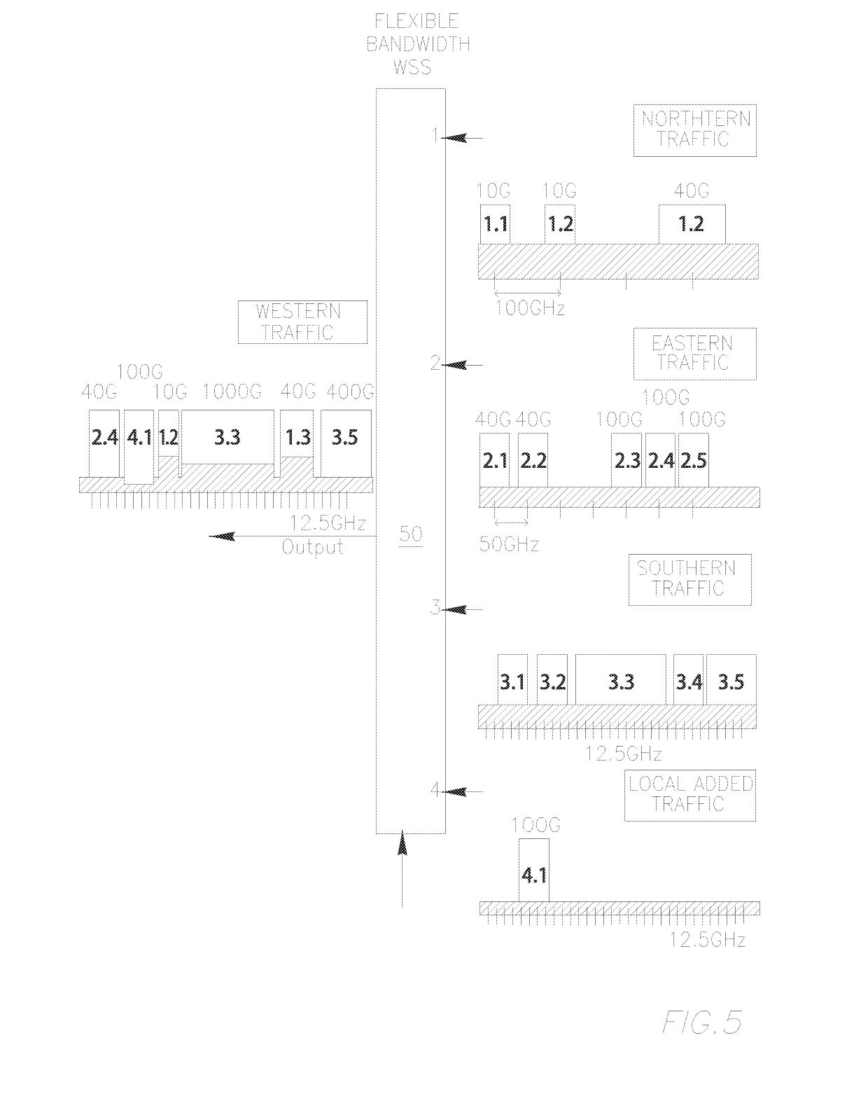

FIG. 4A shows an exemplary apparatus of the OSA monitor 30. This can be a tunable narrow bandpass filter 32 with Δf as filter bandwidth connected to an accurate and sensitive Optical Power Monitor (OPM) 34. The OPM assigns an optical power level (generally expressed in dBm) at every frequency pixel of the optical spectrum band. The power level information is then fed to a band occupancy detector circuit 36 that will determine whether a signal power is present at the resolution of a pixel frequency Δf. In order to distinguish a signal from the noise, the band occupancy detector circuit 36 will consider that a frequency pixel is occupied by a portion of the signal band if its power is higher than a reference threshold power. When the band occupancy detector considers that the pixel frequency is occupied by a signal, it won't change the information of optical power level assigned to this pixel frequency; in the opposite case, it may, for example, replace the power level information by a flag denoted FOS indicating that the pixel is Free Of Signal. The flag will be sent to the NTC. Since the optical noise floor level evolutes in the network from node to node, the noise floor level can be determined using a floor level detection algorithm or by using the expected noise floor level provided by the network control plane (say, by NTME) and then forwarded to OSA monitor controller 38 which is part of NTC 22-see FIG. 3A). The reference threshold power is then determined by a level offset from the noise floor level.

The band occupancy detection processes as following:
1. Estimation of the optical power level—at every pixel frequency of the optical band
2. Estimation of the noise floor level—using noise floor detection algorithm or input provided by NTME.
3. For each pixel frequency, comparison of the pixel power level to the signal occupancy threshold level
   3.1. If the pixel power level is higher than the signal occupancy threshold level, the power level assigned to the pixel frequency is unchanged as the pixel frequency is found to be occupied by a portion of a signal
   3.2. Otherwise, the pixel is found to be free of signal and the power level information is replaced a FOS flag.
4. The information of the spectral band occupancy segments is sent to the NTME which, preferably, is preliminarily provided with information about the minimal required bandwidth for each specific service/channel.

Alternatively, in order to increase the scanning and processing timescale, an OSA monitor 40 can be composed by several elementary OSA monitor units as shown in FIG. 4B. An optical splitter 1×M (42) sends the optical band to be analyzed to a group 44 of M elementary OSA monitors, each one scanning a defined portion of the optical spectrum band. The band occupancy information collector 46 combines the information provided by each elementary OSA monitor unit, and transmits it to the NTC.

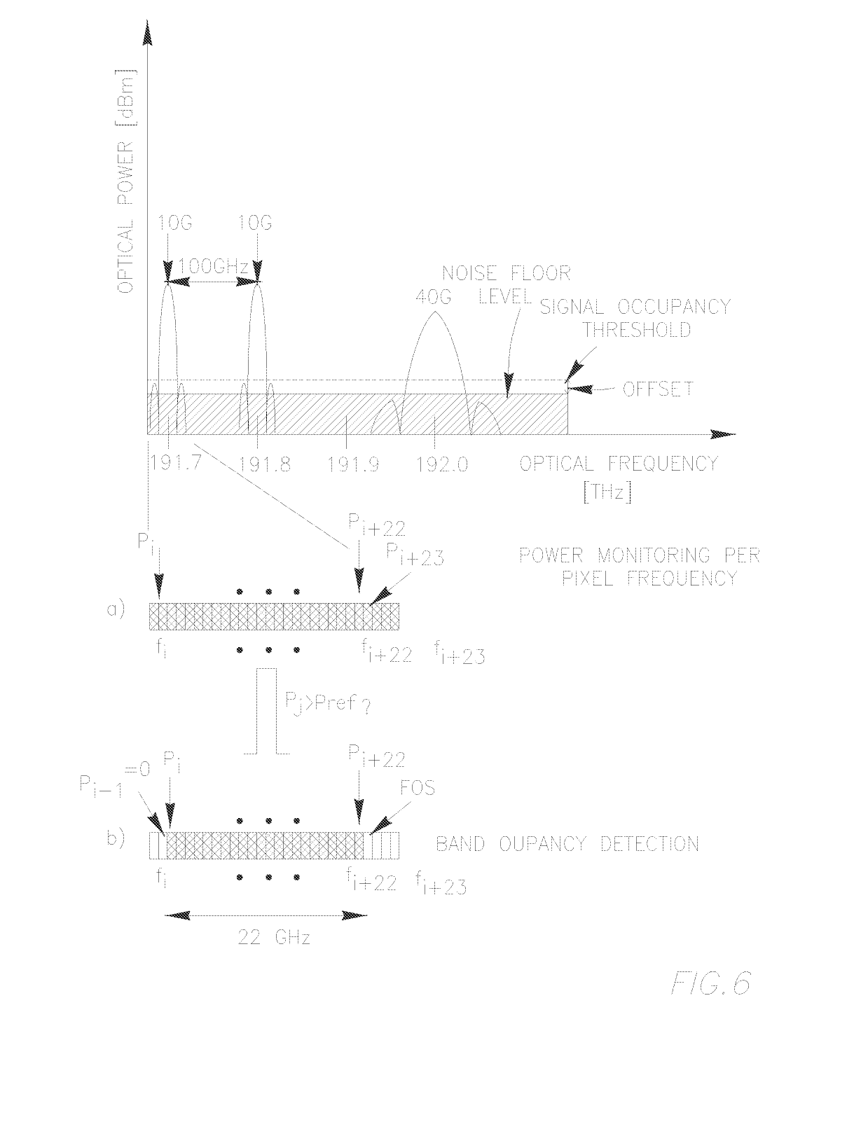

FIG. 5 shows an exemplary case of different services incoming to a flexible grid WSS module 50 (with FBₘᵢₙ=12.5 GHz, Δf=1 GHz) located at the western exit of node N1 of the network described in FIG. 2. (See also the “West” degree in FIG. 3A). The services from the northern traffic (coming from a legacy network MN1 with 100 GHz fixed channel spacing) are connected to the WSS input 1. These services, for example, comprise 10G services based on 10.7 Gb/s OOK modulation format and having 22 GHz optical bandwidth as well as a 40G services based on 44.6 Gb/s DPSK modulation format and having a 82 GHz optical bandwidth.

The services from the eastern traffic (coming from a legacy network MN2 with 50 GHz fixed channel spacing) are connected to the WSS input 2. These services, in our example, comprise 40G services based on 44.6 Gb/s RZ-DQPSK modulation format and having a 45 GHz optical bandwidth as well as a 100G services based on 127 Gb/s DP-QPSK modulation format and having a 45 GHz optical bandwidth.

The services from the southern traffic (coming from the flexible grid network CN 10 with FBmin=12.5 GHz, Δf=1 GHz) arrive to WSS input 3. These services, for example, comprise 100 Gb/s services channels based on 127 Gb/s DP-QPSK modulation format and having a 45 GHz optical bandwidth as well as a 1 Tb/s service based on 1.27 Tb/s PM-32 QAM modulation format and having a 150 GHz optical bandwidth and 400G services based on 446 Gb/s PM-16 QAM and having a 75 GHz optical bandwidth. A Local service is added to the input 4 of the WSS and is composed by a 100G service based on 127 Gb/s DP-QPSK modulation format and has a 45 GHz optical bandwidth.

According to the information provided by the NTC, and NTME (say, about priorities of various channels/services for cases they cannot be combined and start “to compete) the WSS blocks the “unwanted” services (which are present and passed through other degrees of the node) and combines the required services, as shown at the output of the WSS 50. Additionally, the WSS can narrow the optical bandwidth of some outgoing services in order to increase the spectral efficiency SE by allowing addition of new services between two existing services or in order to allow the combination of two existing services while reducing the channel crosstalk.

The noise levels at the different inputs to the WSS as well as at the WSS output are also indicated (shown in in FIG. 6, see the dashed noise blocks). Different incoming signals may present different noise levels.

According to the commands provided by the NTC, the WSS acts as following:
1) For the northern traffic (see N in FIG. 3): Blocking the 10G service (noted 1.1), passing the 10G service, noted 1.2 by allowing filter centered around the channel wavelength with an optical bandwidth of 22 GHz and passing the 40G service, noted 1.3 by allowing filter centered around the channel wavelength with an optical bandwidth of 40 GHz.
2) For the eastern traffic (E in FIG. 3): Passing the 40G service, noted 2.1 by allowing filter centered around the channel wavelength with an optical bandwidth of 45 GHz, blocking the 40G service, noted 2.2 and three 100G services noted 2.3, 2.4 and 2.5.
3) For the southern traffic (S in FIG. 3): Blocking the 100G services, noted 3.1, 3.2 and 3.4, Passing the 1 Tb service, noted 3.3 by allowing filter centered around the channel wavelength with an optical bandwidth of 150 GHz, and passing the one 400G service noted 4.3 by allowing filter centered around the channel wavelength with an optical bandwidth of 75 GHz.

4) For the local added traffic: Passing the one 100G service, noted 4.1 by allowing filter centred around the channel wavelength with an optical bandwidth of 45 GHz.

FIG. 6 shows, as an example, the optical spectrum of the northern traffic arriving to the western exit of node 1 (see W of FIG. 3; see FIG. 5, input 1) which, for example, is composed from two 10G services (10.7 Gb/s OOK signals with carrier frequency at 191.7 THz and 191.8 THz) and one 40G service (44.6 Gb/s DPSK signal with carrier frequency at 192.0 THz). A “zoom” into the optical band (around 191.7 THz) analyzed by the OSA monitor with a resolution Δf=1 GHz is also shown below, at the power monitoring stage a) and band occupancy detector stage b).

The OSA monitor (such as 30 or 40), assigned to the northern traffic, measures the optical power (see the upper zoom “a”) of the signal band with a frequency resolution Δf=1 GHz (the resolution is illustrated as the width of cells of the frequency ruler of the zoom).

The band occupancy detector (such as 36) compares the power assigned to each pixel frequency with the band occupancy threshold level and determines which frequency pixels are stated as FOS (free of signal) and therefore determines the signal bandwidth occupancy for each service (see the lower zoom “b”). For the 10G service located around 191.7 THz, the band occupancy detector finds that its spectral band occupancy segment is between [191.689, 191.711] (expressed in THz units). Additionally for the second 10G service, the spectral band occupancy segment is found to be [191.789, 191.811] and for the 40G service, the spectral band occupancy segment is found to be [191.958, 192.042].

Then the OSA monitor (not shown here) provides to the NTC the following three spectral band occupancy segments information ([191.689, 191.711], [191.789, 191.811] and [191.958, 192.042]).

The NTC assigns the spectral band occupancy segments information to the northern traffic and sends it to the NTME (Network Traffic Management Engine). Similarly the NTC proceeds similarly for the spectral band occupancy segments information provided by the OSA monitors from all the other node traffic streams. The NTME provides to the NTC the traffic mapping information of the node.

The NTC uses the received spectral band occupancy segments information along with the traffic mapper information in order to assign the measured bandwidth occupancy to each service present in the node. Using the traffic mapper information, the NTC is aware of which services should go through each node exits and commands the WSS to pass the traffic with optical filters corresponding to the bandwidth occupancy of each service.

In case of overlapping of signal band occupancy between two services, the optical filter bandwidth at the WSS module can be optimized, to avoid channel crosstalk.

For example, the 40G service (with spectral band occupancy segment [191.958, 192.042]) coming from the northern traffic should go through the western exit node as well as the 1T service from the southern traffic (with spectral band occupancy segment [191.825, 191.970]) and 400G service (with spectral band occupancy segment [192.027, 192.102]) from the southern traffic. By comparing their signal bandwidth occupancy, the NTC detects channel bandwidth overlapping of the 40G service with the 1T service at the lower frequency side and with the 400 G service at the higher frequency side. By looking at the traffic mapping information, the NTC knows that this 40G service uses 44.6 Gb/s DPSK modulation which minimum required bandwidth is 40 GHz, whereas the 1T service uses 1.27 Tb/s PM-32 QAM modulation format whose minimum required bandwidth is the measured bandwidth by the OSA monitor (meaning 150 GHz), and the 400G uses 446 Gb/s PM-16 QAM modulation format whose minimum required bandwidth is the measured bandwidth by the OSA monitor (meaning 75 GHz). Since the measured bandwidth of the 40G is 84 GHz, it can be passed through the flexible grid WSS by allowing it to pass through a filter bandwidth of 40 GHz only centered around the central bandwidth occupancy frequency, reducing its spectral band occupancy segment to [191.98, 192.02]. As a consequence, the 1T and 400G services can be added to the 40G service without channel crosstalk. It is to note that the information of the new spectral band occupancy segment of the 40G service will be refreshed at the next network node (meaning, for example, node N5 in FIG. 2).

Returning to FIG. 2, and to FIG. 3A illustrating the novel network, the following operations can be described, to clarify the proposed method.

When new services are requested to be added at the node, a request is sent by the NTME to the NTC of all the network nodes. In return, each NTC sends to the NTME the list of unused available spectral band segments at their node outputs.

The NTME feeds the software product, comprising the RSA algorithm, with the information of unused available spectral band segments from all the network nodes, with minimal required bandwidth for each of the channels, and determines the optimal route for the requested new service by allocating it in the requested spectral occupancy segment. When the lightpath of the service is determined, the NTME updates the network traffic mapper and send orders to the NTC of the node where the service is added, in order to:
1) Select an available unused transmitter which can provide the requested service
2) Select the channel wavelength of the new service according the RSA algorithm output
3) Allocate the lightpath within the node to enable the service to reach the requested node degree output (by activating optical cross connect and/or tunable filter sand/or WSS elements with requested filter bandwidth and central frequency)
4) Allocate the requested filter bandwidth and central frequency at the requested WSS element located at the requested node degree output.

Additionally, the NTME may send orders to the NTC of transit nodes within a new traffic light-path (between a number of nodes), in order to open the path for the new services by allocating the requested filter bandwidth and central frequency at the WSS elements within the service lightpath.

The NTC of each transit node will activate the requested WSS element to let the service go through sequentially, only when the new service is detected at the node input by the OSA monitor. This sequential turn up process of the lightpath will enable to avoid network instabilities by preventing noise loading in the new service lightpath while the service has not been established yet at the transmitter of the initial node.

At the terminal node of the new service, the NTME send orders to the NTC of the terminal node where the service is dropped in order to:
1) Select an available unused receiver for the requested service;
2) Allocate the lightpath within the node to enable the service to reach the selected receiver (by activating optical cross connect and/or tunable filter sand/or WSS elements with requested filter bandwidth and central frequency).

It should be noted that optical filter(s) of one or more specific existing channels can be regulated based on measuring BER of the received optical signal transmitted in said channel(s) and/or according to the minimum required optical bandwidth of the channel provided by the traffic mapper to the Node Traffic Controller. The regulation preferably comprises slightly shifting the bandpass of the filter of interest and shaping it, to free space for new channels; the bandwidth may be shifted with simultaneously controlling the channel quality by means of measuring BER.

It should be kept in mind, however, that minimizing of bandwidth is not recommended to perform automatically for each and every optical channel, since such a uniform approach would be harmful for the network and would shorten the distance of propagation for many optical channels. The method is supposed to provide the bandwidth minimizing for some specifically selected optical channel(s), in case their limited bandwidth would allow inserting additional optical channels near them or there-between.

It should be appreciated that other embodiments of the network node and other versions of the method might be proposed though are not particularly described as examples in the above description; they should be considered part of the invention whenever defined by the claims which follow.

### REFERENCES

[1] S. Tibuleac, “ROADM Network Design Issues,” in Proc. OFC/NFOEC 2009, paper NMD1.
[2] M. Jinno and Y. Tsukishima, “Virtualized Optical Network (VON) for Agile Cloud Computing Environment,” in Proc. OFC/NFOEC 2009, paper OMG1.
[3] R. J. Essiambre et al., “Capacity limits of Optical Fiber Networks,” IEEE/OSA J. Lightwave Tech., vol. 28, no. 3, Feb. 15, 2010, p. 662.
[4] R. Ryf et al., “Wavelength Blocking Filter with Flexible Data Rates and Channel Spacing,” J. Lightwave Tech., vol. 23, no. 1, 2005, p. 54.
[5] S. Sygletos et al., “Numerical Study of Cascadability Performance of Continuous Spectrum Wavelength Blocker/Selective Switch at 10/40/160 Gb/s,” IEEE Photonics Tech. Letters, vol. 18, no. 24, 2006, p. 2608.
[6] US 2004142696
[7] U.S. Pat. No. 5,949,832
[8] US 2011033188
[9] O. Turkcu and S. Subramaniam, “Blocking in Reconfigurable Optical Networks,” Proc. IEEE INFOCOM '07, 2007, p. 188.
[10] K. Christodoulopoulos, I. Tomkos and E. A. Varvarigos, “Routing and Spectrum Allocation in OFDM-based Optical Networks with Elastic Bandwidth Allocation”, in Proc. IEEE GLOBECOM 2010

1. A method for improving bandwidth efficiency in an optical network by dynamically utilizing unused bandwidth located around preliminarily allocated optical channels, by monitoring actual bandwidth of the preliminarily allocated optical channels incoming to a node of the optical network, reporting the monitoring results to a node controller of said node and further to a network controller, receiving at said node recommendations generated by the network controller, adjusting bandwidth of one or more of the allocated optical channels thereby releasing spare bandwidth spacing for inserting one or more additional optical channels thereat.

2. The method according to claim 1, wherein utilizing unused bandwidth located around the preliminarily allocated optical signals of a grid initially existing in the network, comprising:
a first step of monitoring the existing grid of the allocated channels in the network and finding suitable remaining bandwidth in the existing grid for further use;
a second step of releasing suitable bandwidth around the preliminarily allocated channel(s), for inserting said one or more additional optical channels; and
a third step of utilizing the released bandwidth spacing by inserting the one or more additional channels there-into.

3. The method according to claim 2, wherein the second step comprises controlling a tunable optical filter of a specific optical channel to narrow, shift and/or shape bandwidth of a signal transmitted over said specific channel.

4. The method according to claim 2, wherein the second step comprises controlling a tunable optical filter of a specific optical channel, under control of BER of the signal carried over said optical channel, and/or according to information about the minimum required optical bandwidth of the channel.

5. The method according to claim 2, wherein the optical network is either gridless or has a flexible grid of optical channels.

6. The method according to claim 5, wherein the flexible grid is a mini-grid with granularity less than 50 GHz.

7. The method according to claim 1, wherein said adjusting of bandwidth comprises shifting bandwidth of one or more of the allocated optical channels at a specific node, so as to produce a broader spacing and allow inserting said one or more additional optical channels into thus obtained broader spacing.

8. The method according to claim 1, comprising interleaving of channels of different grids with preliminarily cleaning the unused bandwidth from noise, and/or with narrowing the preliminarily allocated optical bandwidth.

9. The method according to claim 1, further comprising the following steps:
in case one or more additional optical channels are to be added at a specific node, sending a request by the network controller to node controllers of one or more network nodes;
in return, sending from each of said one or more network nodes to the network controller, via their respective node controllers, a list of unused available spectral band segments.

10. An optical switching network node comprising:
a node traffic controller NTC in communication with a Network Controller NC;
one or more blocks for monitoring optical channels incoming the node from at least two sources having different grids of optical channels, and for informing the NC about bandwidth occupancy of said grids;
one or more suitable bandwidth adjustment blocks, wherein each of said bandwidth adjustment blocks:
serving a group of incoming optical channels characterized by a specific grid;
being adapted to obtain recommendations from the Network Controller NC and, based on the received recommendations, to shape and/or narrow bandwidth of one or more incoming optical channels of the group so as to prepare space for inserting there-between optical channels arriving from another source and characterized by another grid.

11. The node according to claim 10, wherein the NTC is adapted to collect band occupancy information from the monitoring blocks and to calculate, alone or in cooperation with the NC, a possible arrangement of incoming channels in an optimized manner from the point of bandwidth utilization.

12. The node according to claim 10, wherein the monitoring block comprises one or more Optical Spectrum Analyzer (OSA) monitors providing information about services bandwidth occupancy and unused optical bandwidths on the incoming channels, as well as on local channels to be added, by measuring optical power.

13. The node according to claim 10, wherein the spectral resolution is measured in the order of frequency pixel resolution of the grid or of about 1 GHz in case of a gridless network.

14. The network node according to claim 10, further comprising one or more controllable wavelength shifting elements WSE, said WSE being adapted to shift bandwidth of one or more optical channels in the network node.
